(19) United States
(12) Patent Application Publication
(10) Pub. No.: US 2021/0239949 A1
(43) Pub. Date: Aug. 5, 2021

(54) METHOD AND SYSTEM FOR RECORDING AN IMAGE USING ONE OR MORE PRISMS

(71) Applicant: National University of Singapore, Singapore (SG)

(72) Inventor: Mark BREESE, Singapore (SG)

(21) Appl. No.: 17/045,051

(22) PCT Filed: Mar. 14, 2019
(86) PCT No.: PCT/SG2019/050141

§ 371 Date: Oct. 2, 2020

(30) Foreign Application Priority Data
Apr. 3, 2018 (SG) 1020180102764U

(51) Int. Cl. G02B 13/06; G02B 5/04; G02B 27/12

(52) U.S. Cl. CPC G02B 13/06; G02B 27/126; G02B 5/04

(57) ABSTRACT

A method and system for recording an image using a camera. The method comprises the steps of: disposing a first reflective prism in front of the camera such that the first prism deflects light from a first field of view onto a sensor of the camera, wherein the first field of view extends symmetrically around a non-perpendicular direction relative to an entrance lens surface of the camera; capturing a first image over at least a portion of the first field of view using the sensor; and capturing a second image over at least a portion of a second field of view different from the first field of view using the same sensor with the first prism in place in front of the camera.

### FIELD OF INVENTION

The present invention relates broadly to methods and systems for recording an image using one or more prisms, in particular wide-angle viewing and detection using one or more prisms.

### BACKGROUND

Any mention and/or discussion of prior art throughout the specification should not be considered, in any way, as an admission that this prior art is well known or forms part of common general knowledge in the field.

It has been proposed that a small, single prism which is placed on top of the front or back camera entrance surface, for example in a smartphone, alters the viewing direction by an angle which depends on the prism geometry, typically in the range of 55° to 75°.

Embodiments of the present invention seek to further develop methods and systems for recording an image using one or more prisms, in particular to provide a wide angle field of detection (and/or transmission) of light.

### SUMMARY

In accordance with a first aspect of the present invention, there is provided a method of recording an image using a camera, the method comprising the steps of:
disposing a first reflective prism in front of the camera such that the first prism deflects light from a first field of view onto the sensor of the camera, wherein the first field of view extends symmetrically around a non-perpendicular direction relative to an entrance lens surface of the camera;
capturing a first image over at least a portion of the first field of view using the sensor; and
capturing a second image over at least a portion of a second field of view different from the first field of view using the same sensor with the first prism in place in front of the camera.

In accordance with a second aspect of the present invention, there is provided a camera device comprising:
a first and reflective prism disposed in front of a camera unit of the camera device such that the first prism deflects light from a first field of view onto the sensor of the camera unit, wherein the first field of view extends symmetrically around a non-perpendicular direction relative to an entrance lens surface of the camera unit;
wherein the camera device is configured for capturing a first image over at least a portion of the first field of view using the sensor and for capturing a second image over at least a portion of a second field of view different from the first field of view using the same sensor with the first prism in place in front of the camera.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1(a) shows a schematic diagram illustrating full-range of incident angles into camera with normal viewing direction.

FIG. 1(b) shows a schematic diagram illustrating restricting (half) range of incident angles into camera with normal viewing direction.

FIG. 1(c) shows a schematic diagram illustrating restricting (other half) range of incident angles into camera with normal viewing direction.

FIG. 2(a) shows a schematic diagram illustrating full-range of incident angles into camera in conjunction with single prism to deflect central ray.

FIG. 2(b) shows a schematic diagram illustrating restricting range (different halves) of incident angles into camera in conjunction with single prism to deflect central ray.

FIG. 3 shows a schematic diagram illustrating restricting range of incident angles into camera in conjunction with two prisms, according to an example embodiment. Separate shading merely highlights the different full-colour FOV which are separately recorded, it does not imply any wavelength selection.

FIG. 4(a) shows a schematic diagram illustrating use of a two prism camera to provide two FOVs which extend the angular range of a second camera of a two camera system, according to an example embodiment.

FIG. 4(b) shows a schematic diagram illustrating use of a two prism camera to provide two FOVs which extend the angular range of a second camera of a two camera system, according to an example embodiment. In this embodiment, no light shields are required for the two prism camera.

FIG. 5 shows a schematic diagram illustrating use of a two prism camera to provides two FOVs which extend the angular range of a second camera of a two camera system, according to an example embodiment.

FIG. 6 shows a schematic diagram illustrating a contiguous field of view extending over the linear sum of the separate FOVs of the camera of a two camera system, according to an example embodiment.

FIG. 7 shows images illustrating use of different colour filters in front of a single camera.

FIG. 8 shows a schematic diagram illustrating use of different colour filters in front of two prisms on a single camera, according to an example embodiment.

FIG. 9 shows a schematic diagram illustrating use of liquid crystal (LC) layer in front of two prisms on a single camera, according to an example embodiment.

FIG. 10(a) shows a schematic diagram illustrating restricting range of incident angles into camera in conjunction with one prism and with a second FOV provided by exposed camera surface recording image normal to surface, according to an example embodiment.

FIG. 10(b) shows a schematic diagram illustrating restricting range of incident angles into camera in conjunction with two prisms and with a third FOV provided by exposed camera surface recording image normal to surface, according to an example embodiment.

FIG. 11 shows images and a schematic diagram illustrating use of mechanical or electrical shutters to switch between three different viewing directions, according to an example embodiment.

FIG. 12 shows schematic diagrams illustrating use of a cube prism on a single camera for two orthogonal full FOVs, according to an example embodiment.

FIG. 13 shows schematic diagrams illustrating use of a cube prism and a single camera for two orthogonal half FOVs, according to an example embodiment.

FIG. 14 shows images and schematic diagrams illustrating blind spots for buses and lorries.

FIG. 15 shows a schematic diagram illustrating bus and lorry blind spots in forward direction.

FIG. 16 shows a flow chart illustrating a method of recording an image using a camera, according to an example embodiment.

FIG. 17 shows a schematic diagram illustrating a camera device according to an example embodiment.

### DETAILED DESCRIPTION

The definition of the field-of-view (FOV) as used herein refers to the angular extent of the field of view in a single direction, normally assumed as the horizontal direction. It is not the same definition of FOV as is commonly used elsewhere, which is typically the root-mean-square value of the fields of views in the horizontal and vertical directions, i.e. the maximum angular extent. Furthermore, for clarity of description of the underlying method, no account is taken here of an angular overlap between adjacent fields of view which to be used in order to properly stitch photos and videos together according to example embodiments of the present invention. Also, “image” is generally used herein as including “video”, noting that embodiments of the present invention apply equally to both unless otherwise stated herein.

Embodiments of the present invention provide use of a single camera to record images and videos containing two fields-of-view (FOV) located at wide angles with respect to the surface normal, i.e. outside the field of view as seen by the same camera recording a standard image in surface normal direction. If used in conjunction with a second camera which records an image or video with a standard direction, the composite, field of view is extended beyond that which is achieved using a single camera, according to example embodiments. Software stitching is used in example embodiments to suitably combine the various segments of the composite field of view. While not limited to the dual camera systems available on many smartphones, this is an evident application and several of the example embodiments described herein are aimed specifically at this area. In some embodiments provided use of a single camera to sequentially record two or three different fields of view which can be stitched together to form a wide angle composite photograph. More generally, embodiments of the present invention disclose how a single light sensor, which may be a camera or another form of optical device can be used to detect light over a wider field of view than that defined by the lens.

Embodiments of the present invention provide use of more than one prisms positioned on the same camera entrance surface. The prisms are oriented in opposite directions according to example embodiments so that each prism deflects light into the same camera from opposite directions with respect to the surface normal, so that the sensor detects a combination of both FOVs. The specific amount of each FOV from each direction depends on many factors, including the size and deflection angle of the prisms, their separation, and the aperture size and FOV of the camera on which they are placed. There are several embodiments of the present invention described herein which differ in how the FOV from each prism are separated so that they are recorded on the sensor in a manner which can be deconvoluted into two separate images or videos.

Embodiments of the present invention disclose how one or more small prisms can be arranged to generate images and/or videos from two cameras over wide angles of up to, or even exceeding 180°. This is achieved according to example embodiments using one camera to record images and videos containing two fields-of-view (FOV) located at wide angles with respect to the surface normal, i.e. outside the field of view as seen by the same camera recording a standard image in surface normal direction. If used in conjunction with a second camera which records an image or video with a standard direction, the composite, field of view is extended beyond that which is achieved using a single camera, according to example embodiments. Software stitching, as is understood by a person skilled in the art, is used to suitably combine the various segments of the composite field of view according to example embodiments. While not limited to the dual camera systems available on many smartphones, this is an evident application and several of the examples given are aimed specifically at this area. In some embodiments it is shown how a single camera may be used to sequentially record two or three different fields of view which can be stitched together to form a wide angle composite photograph.

### Example Embodiments Using Shields to Block Half the Field of View from Each Direction

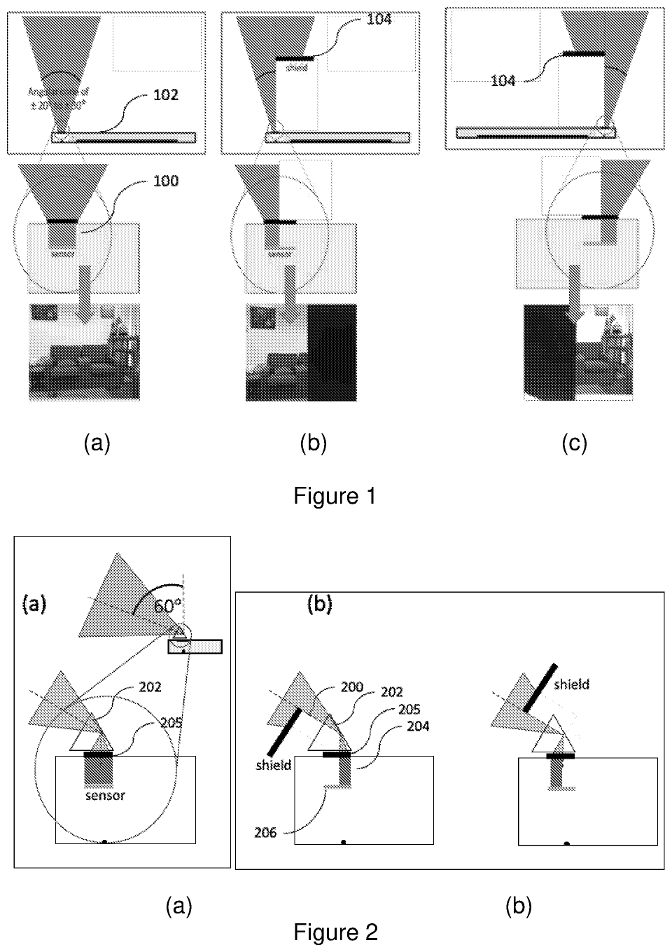

Consider FIG. 1(a) which shows a (rear) camera 100 on a smartphone 102, though the same concept is applicable to all other devices incorporating miniature digital cameras. The camera 100 records an image over a certain field of view (FOV), extending symmetrically about the direction perpendicular to the entrance lens surface. If, as shown in FIG. 1(b), half the FOV is deliberately blocked out by suitable placement of a light-shield 104 then half of the image sensor records no image, that is, it looks black. If instead the other half of the FOV was blocked out then the other half of the sensor would record the other half of the full image seen using full FOV and the other half of it would appear black, as shown in FIG. 1(c).

The term “light shield” can mean a simple, fixed, mechanical barrier which stops light entering a part of, or the whole of a prism, or it can be an electrically operated barrier which can be moved on demand so that it is open or closed, that is a “shutter”. Such an electrically operated barrier may comprise an actuator to move a mechanical shutter, or an electrical shutter in which light transmission is controlled by the application of a voltage to a suitable layer.

FIGS. 2(a) and (b) illustrate the principle of using a light shield 200 applied, according to an example embodiment, to a single prism 202 located on top of a camera 204 on an entrance lens surface 205. In FIG. 2(a) the full FOV is deflected by an angle determined by the prism 202 geometry, typically by 60°. If the angular range of light entering the prism 202 is restricted to half the full FOV using the shield 200, then an image is transmitted to only half of the sensor 206 area, FIG. 2(b) left-hand picture. If the other half of the FOV is selected, FIG. 2(b) right-hand picture, then an image is formed on the other half of the sensor 206 area.

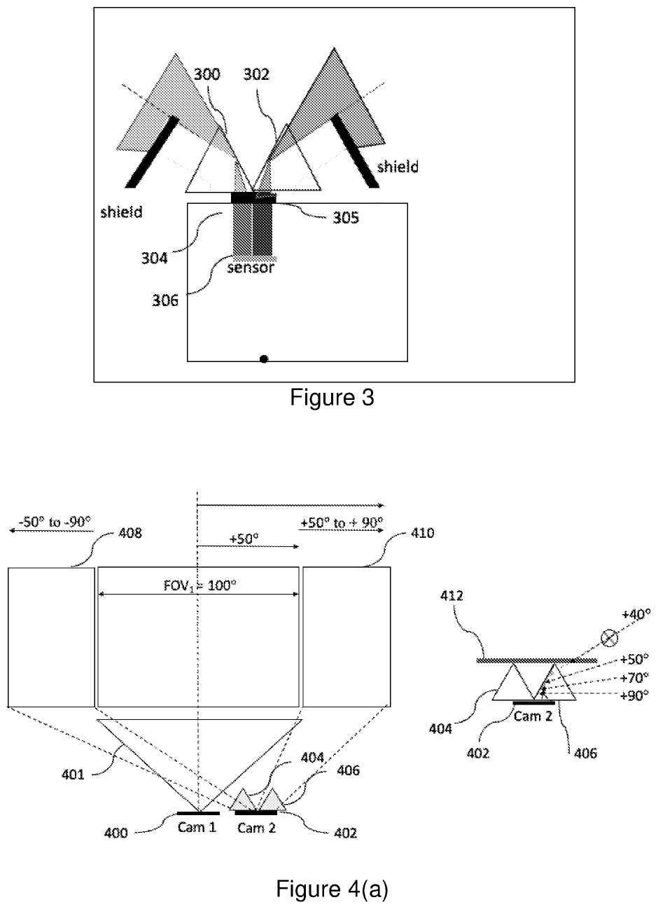

FIG. 3 shows this same principle applied, according to an example embodiment, to two prisms 300, 302, which are located on top of a miniature camera 304 on an entrance lens surface 305. It is important to note that the two prisms 300, 302, which both accept half of their full FOV, but from different directions, direct light to different halves of the sensor 306 so that the each is recorded without any interference from the other.

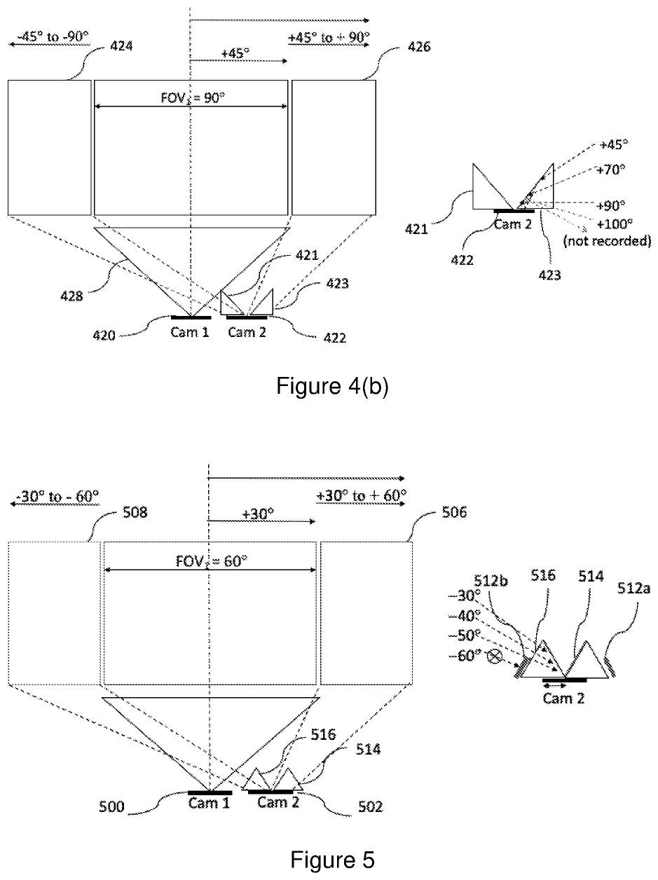

A full colour image or video is recorded from two wide angle FOV by the single sensor 306. Software processing can then be used to separate the two halves and add them to either side of the FOV of a second camera, forming a composite display which extends of the sum of the FOV of both cameras, according to an example embodiment. By way of example, three implementations of this method according to example embodiments, as shown respectively in FIGS. 4 and 5, will be described herein. In all three cases, one camera has no prisms and records a “standard” FOV perpendicular to the surface normal. In FIG. 4(a) camera 400 has a wide field of view 401 of 120°, i.e. ±60°. To further extend this, the separate components from camera 402, which has two equilateral prisms 404, 406 located on it are used according to an example embodiment. If camera 402 has a total FOV of 60°, then one can break this up into two components 408, 410, each of 30° FOV, and arrange each so that they both contribute to the total FOV with an additional range of (+60° to +90°), and (−60° to −90°), according to this example embodiment. This is done using prisms 404, 406, which each deflect the central ray by 60°. The sum of the two camera 400, 402, FOV now extends over 180°. This embodiment uses blocking of the halves of the FOV which are closer to the surface normal, with a suitable shield 412 covering the top of the composite device.

In FIG. 4(b) another embodiment for producing wide field of view is shown. In this embodiment, the FOV of both cameras 420, 422 is 90°. Two right-angle prisms 421, 423 are placed over one camera 422 so that it allows two separate FOV from (+45° to)+90° 424, and (−45° to −90°) 426 to be recorded on the sensor. Light from angles greater than ±90° may enter the prism e.g. 423 but it is not recorded on the camera sensor because it either is outside the FOV and also may not fall on the sensor. The FOV 428 of the other camera is from (+45° to −45°), so the sum of the two FOV extends over 180°. This embodiment shows that different prism geometries may be used, depending on many factors such as the FOV of each camera. It also highlights that under certain conditions no light shields are required to limit the FOV entering either side of the two prism camera.

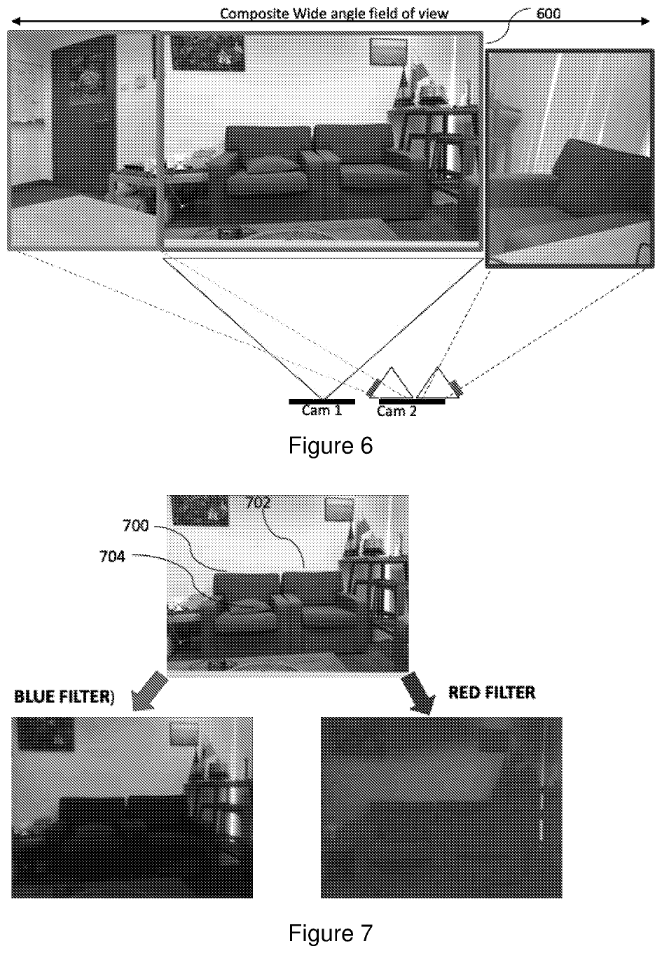

FIG. 5 shows an example embodiment where the two cameras 500, 502 are identical, each with a smaller FOV of 60°. Camera 500 thus provides a FOV 504 over ±30°. Camera 502 contributes an additional 30° to either side of the FOV of camera 500, i.e. with an additional range of (+30° to)+60°, 506, and (−30° to −60°), 508. This is achieved in this embodiment by allowing only light from the less deflected half of the FOV to be transmitted to the sensor. A different form of shield 512a, b is used for this as compared to the embodiment shown in FIG. 4(a), relying on blocking light from the wider deflection angles from entering the prisms 514, 516 and sensor. FIG. 6 shows an example composite image 600 obtained using the embodiment of FIG. 5.

It will be appreciated that choosing between the embodiments presented in FIGS. 4 and 5 depends on the FOV of each camera being used and what the application is. Here it is highlighted just what flexibility can be introduced into the process of recording using two prisms located on the same camera, according to example embodiments. A further advantage of the example embodiments is that the angular separation between the split fields of view can be varied, by altering the location of the shields, as in FIGS. 4 and 5 for two example embodiments, and also by changing the prism geometry so that the central ray is deflected by different angles in different embodiments. Furthermore, while it is easier to discuss embodiments of the present invention using two identical prisms which deflect light by the same amount, this is not necessary and other versions of this may be developed where the light from the double prisms is deflected by differing amounts, in different embodiments.

Furthermore, while embodiments of the present invention in which blocking is used are discussed in terms of blocking half the FOV, this is not necessary and other versions of this may be developed where different amounts are blocked in different embodiments.

The advantages of the example embodiments of the present invention described with reference to FIGS. 4 to 6 include: two full-colour images or videos are recorded. The absolute angular range of light entering camera 2 can be controlled, for example by using suitably-placed shields and/or by suitably choosing the prism geometries. It is noted that each half of camera 2 only contributes an additional half of its FOV to each additional side of that recorded from camera 1 in those embodiments.

### Example Embodiments Using Colour Filters

There may be situations where one wishes to record over the full FOV from both directions offered by two prisms located on top of a camera, according to some example embodiments. In such embodiments there is no requirement to limit the entrance angular range of each prism using shields. This can be done by placing different colour filters in front of each prism entrance face, e.g. red and blue filters so that the wavelength difference across the visible spectrum is preferably maximum. FIG. 7 shows the different images recorded from the same scene by the use of these two filters. In each, different areas corresponding to that colour are recorded strongly. Thus, with the blue filter the red chairs 700, 702 appear dark, and with the red filter the blue cushion 704 appears dark.

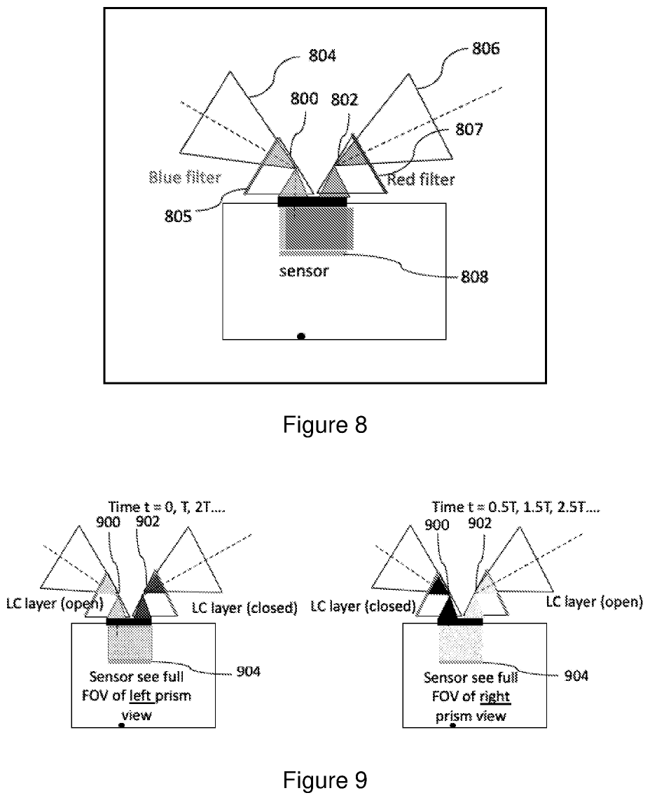

FIG. 8 shows an example embodiment with two prisms 800, 802 recording images over their full FOV 804, 806 from different directions. Each transmits only a narrow wavelength image due to the respective filters 805, 807, and those images which are recorded on the separate red/blue components of the sensor 808 array. The sensor 808 thus records a red image and blue image which can be separated out in software for further processing, according to example embodiments.

The advantages of the embodiment described with reference to FIGS. 7 and 8 include: two images are recorded, each over the full camera FOV. It is noted that each image is substantially monochrome, with information lost in the light stopped by each filter. For applications in certain areas, e.g. machine vision, recording in monochrome may be acceptable and so this embodiment applicable.

### Example Embodiments Using Liquid Crystals

In some example embodiments there are no colour filters or limits on the angular range of light entering the prisms, so the full colour images are recorded over the full FOV from each prism. In such embodiments the two FOV are separated during recording by alternately opening/closing a liquid crystal layer in front of, or beneath each prism 900, 902. The sensor 904 thus sees a full FOV in full colour from each prism 900, 902 direction but only for half the time for a video recording, see FIG. 9.

The advantages of the embodiment described with reference to FIG. 9 include: two full colour images are recorded over each full camera FOV. It is noted that light transmitted through the liquid crystal layer is polarized and so of lower intensity. For wide angle video, images are recorded alternately so timing resolution is important and each image is only recorded for half the total period.

In another mode according to some embodiments, one may choose to use the liquid crystals to switch direction for a photographic or video recording, in which case the electrical signal is applied for a certain period of time, until one wishes to view the other direction.

### Example Embodiments Using Other Combinations of FOV Generated by One or Two Prisms

The example embodiments described with reference to FIGS. 3 to 9 refer to a geometry of two prisms arranged on the same camera, fully covering the exposed camera surface. Further example embodiments are described here in which the camera surface is only partially-covered by one or two prisms, allowing light from the surface normal direction to also be recorded by the sensor. In such embodiments the different FOV may be separated or collimated before being recorded by the sensor as in the example embodiments described with reference to FIGS. 3 to 9, or a combination of them.

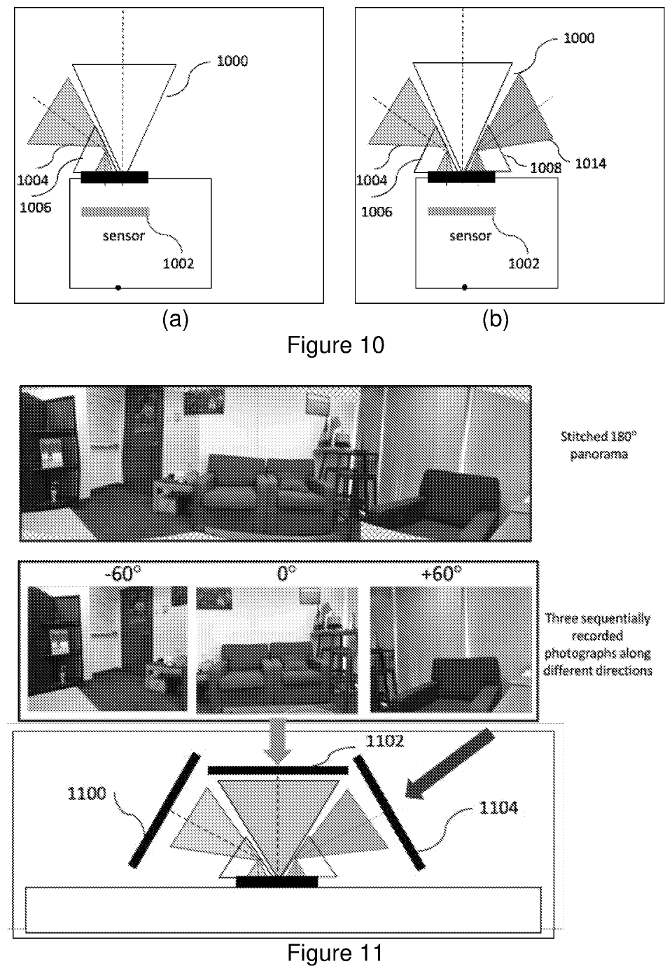

Consider the geometry of two prisms as in FIGS. 3 to 6, but with one prism removed, so that, as shown in FIG. 10(a), the FOV 1000 normal to the surface is also incident on the camera and may be recorded by the sensor 1002. Two FOVs 1000, 1004 are recorded, comprising (i) that centred along the surface normal which originates from the uncovered portion of the camera surface, and (ii) that along a central ray determined by the deflection of the prism 1006, typically 60°, respectively. Images may be recorded at the same time, over half the FOV of each direction, by suitable of placement of shields, or sequentially over the full FOV by use of colour filters or alternating open/closed shutters.

Another example embodiment using basically the same geometry as shown in FIGS. 3 to 6, but now, as shown in FIG. 10(b), the two prisms 1006, 1008 are separated so that a gap is introduced between them. Now, in addition to the two FOV 1000, 1014 from deflected rays entering the prisms, a third FOV 1000 which originates from the uncovered portion of the camera surface normal to the surface is also recorded by the sensor 1002, making a total of three FOV recorded. FIG. 11 shows an example of this case for three viewing directions. By blocking off the other two and only allowing light in through one of the three viewing directions in turn using, for example, mechanical or electrical shutters 1100, 1102, 1104, photographs can be recorded sequentially along different directions and then combined to provide a wide angle view from a single camera. By rapidly changing of electrical shutters placed in front of each viewing direction then this arrangement could also be used to record wide angle videos.

It will be appreciated by a person skilled in the art that in the embodiments described above with reference to FIGS. 3 to 11, the reflectiveness of the reflective prisms is preferably high so as to achieve a high amount of light capture, and advantageously the reflectiveness is substantially 100%.

### Example Embodiments Using Shields to Limit FOV from Two Directions in a Cube Beamsplitter Prism

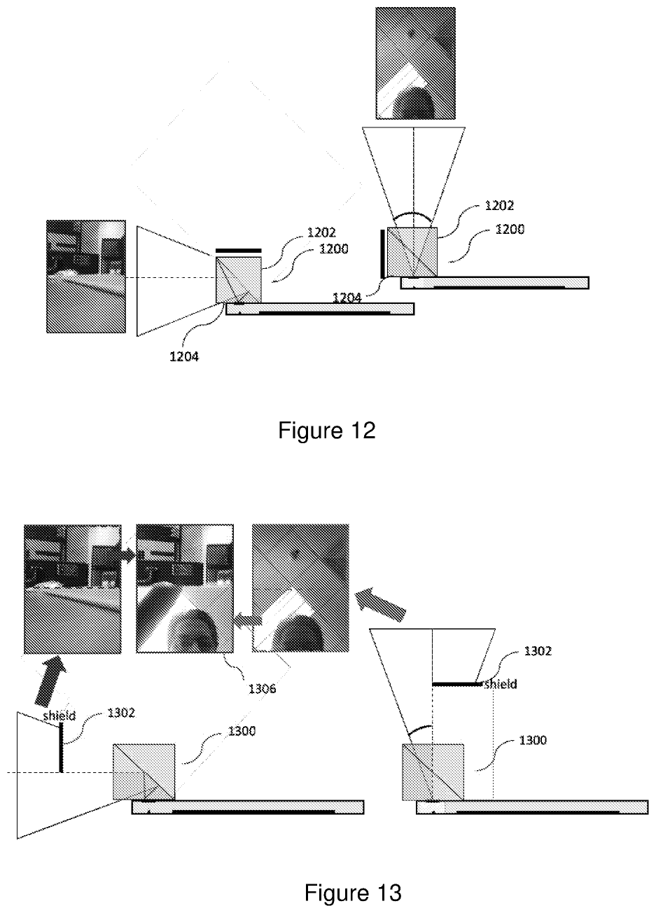

The general method of allowing more than one field of view to be recorded on a single camera sensor can be extended beyond the use of two reflective prisms as in the example embodiments described above. Consider a standard cube beam splitter 1200 in FIG. 12 according to another example embodiment, comprising of two right-angle prisms 1202, 1204 joined together. This device may be used to split light originating from a single direction into beams in orthogonal directions. Conversely it may be used to combine two images in orthogonal directions onto the same direction; as shown, by shielding each face in turn one can see the separate fields of views recorded from the unshielded face. One could use different colour filters, as in the example embodiments using colour filters described above, to transmit different colour images from the two directions onto a single exit direction.

However, one may also use the same approach as in the example embodiments using light shields described above, whereby light shields may be used to select certain FOV along two orthogonal directions. By suitable choice of the FOV, these can be arranged so that again they are recorded on opposite halves of the sensor area, according to example embodiments. Consider FIG. 13 which shows a cube beam splitter 1300 transmitting fields of view from orthogonal directions onto a miniature camera. Now half of the field of view in each direction is shielded using shields 1302, 1304, so that light only falls on the sensor from the other half of the FOV. The resulting image or video 1306 recorded by the sensor shows a combination of the transmitted halves of the two fields of view, according to example embodiments.

As will be appreciated by a person skilled in the art, a cube prism typically reflects a lower percentage, say 50% and transmits the rest, so it can be considered as a partially reflective prism, and is often referred to as a beamsplitter prism.

### Angular Separation Between Fields of View, According to Example Embodiments

Two broad methods of recording different halves of the FOV have been described above according to example embodiments. First, with two prisms as in the example embodiments described with reference to FIGS. 3-6 and second with a cube beam splitter as described with reference to FIG. 13. Consider the angular separation between the two recorded FOV in these two broad methods. For a cube beam splitter the central rays from each full FOV are orthogonal, i.e. an angular separation of 90°. In comparison for two prisms used to record split fields of view, as in FIGS. 3-6, the angular separation is larger; if two equilateral prisms are used where the central ray is deflected by ±60° then the total angular separation is 120°. If instead each prism deflects a central ray by ±70° then the total angular separation is 140°. Thus, very wide angular separation may be more readily achieved using a two prism approach according to example embodiments, and narrower separation may be easier using a cube beam splitter according to example embodiments.

### Application for Eliminating Blind Spots in the Forward Viewing Direction of Vehicles, According to Example Embodiments

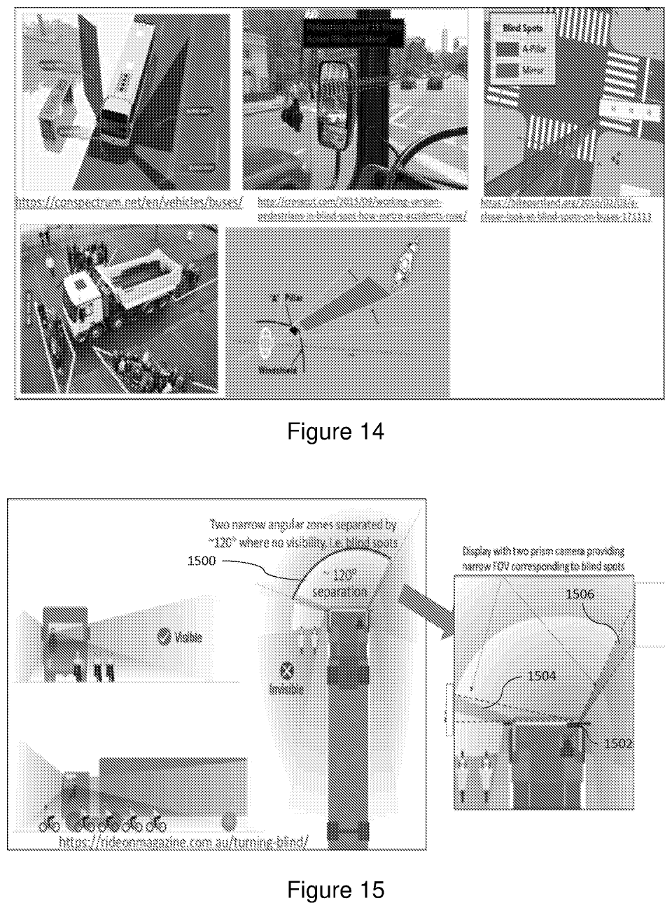

FIG. 14 shows several depictions as to how blind spots in the view provided to the drivers of buses and lorries arise. There are both lateral barriers to sight, such as wing mirrors and the windscreen frame, and vertical limits in that the driver tends to sit up high, and have limited views of pedestrians and cyclists at floor level, both in front and to the vehicle sides.

In FIG. 15 the angle between the two front blind spots produced by the windscreen frame are shown to have an angular separation 1500 of about 120° relative to where the driver sits. This angular separation 1500 is well-suited to that produced by the two-prism devices according to example embodiments described with reference to FIGS. 3-6. If such a device 1502 was placed in front of the driver, e.g. on the vehicle dashboard, it would advantageously provide two narrow fields of view 1504, 1506 at angles corresponding to or covering the blind spots, thus providing a method and system to eliminate the blind spots m according to example embodiments.

### Application for Wide Angle Optical Signal Detection and Transmission, According to Example Embodiments

It has been described above how one may increase the viewing angle of a single camera, as in the example embodiment described with reference to FIG. 10, by the use of prisms to allow light from different directions to be recorded on the same sensor. This uses a single field of view of light to enter the camera. There are, however, other types of optical systems where similar arrangements of prisms have use, namely that of optical signal detection over a wide angle. In this situation, the only requirement may be to detect incident light over a wide incoming angular cone, with no limitations on whether parts of the sensor receive light from different FOV, so now there is no need to restrict the angular cone of light to that of a single prism or exposed surface, as was done in the example embodiments described with reference to FIG. 10.

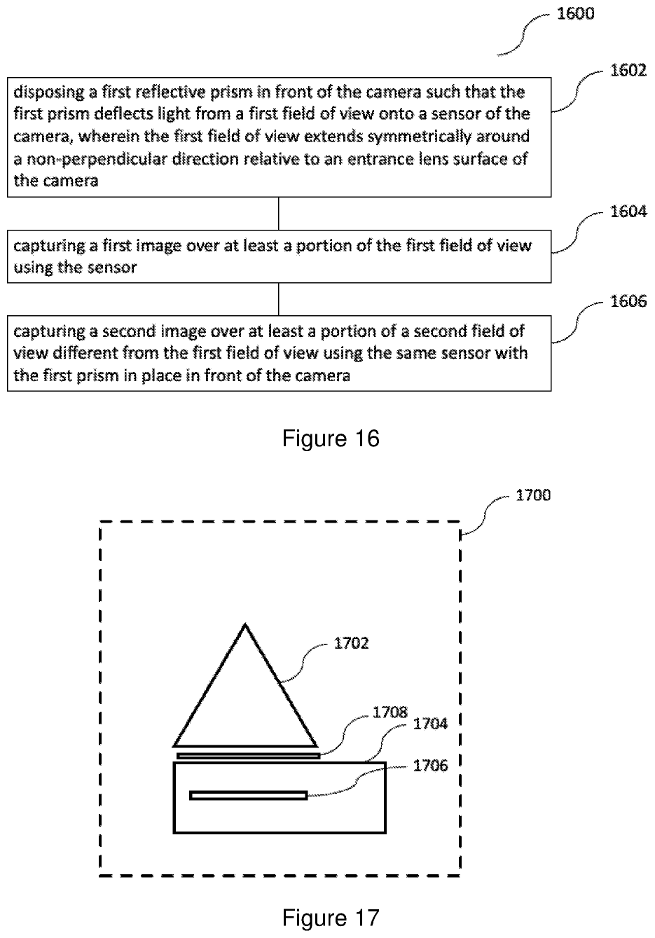

For example, LiFi (visible light-based WiFi) systems are being developed as optically equivalent versions of WiFi. One current problem with them is that they are limited in their detection field of view, with the receiver 1600 in FIG. 16(b) only able to detect light pulses over an angular range of typically ±30° to the surface normal. The prism arrangements described with reference to FIG. 10 can double or triple the field of view and so allow a LiFi receiver to always be within the angular cone of a LiFi-enabled light source. The same applies to the ability of a prism array to transmit, rather than just receive, light over a wide field of view. Furthermore, the field of view may be asymmetric and so tuned to the optimal shape to fit in with the way in which the transmitter/receiver units are held and the distribution of light transmitters and receivers.

FIG. 16 shows a flow chart 1600 illustrating a method of recording an image using a camera, according to an example embodiment. At step 1602, a first reflective prism is disposed in front of the camera such that the first prism deflects light from a first field of view onto the sensor of the camera, wherein the first field of view extends symmetrically around a non-perpendicular direction relative to an entrance lens surface of the camera. At step 1602, a first image is captured over at least a portion of the first field of view using the sensor. At step 1604, a second image is captured over at least a portion of a second field of view different from the first field of view using the same sensor with the first prism in place in front of the camera.

The method may comprise disposing a second reflective prism in front of the camera adjacent to the first prism such that the second prism deflects light from the second field of view onto the sensor of the camera, wherein the second field of view extends symmetrically around a different non-perpendicular direction relative to the entrance lens surface of the camera compared to the first field of view.

The prism may comprise a cube-prism, and the first and second fields of views may extend from orthogonal sides of the cube-prism.

The first and second images may be captured simultaneously.

In one such embodiment, the method may comprise blocking another portion of the first field of view using a first light shield and blocking another portion of the second field of view using a second light shield, and the simultaneously-captured images are recorded on different respective areas of the sensor.

In one such embodiment, the method may comprise applying a first filter during capturing of the first image over the full first field of view and applying a different second filter during capturing of the second image over the full second field of view, and the simultaneously captured images are captured on different color components of the sensor.

The first and second images may be captured individually.

In one such embodiment, the method may comprise selectively blocking the full second field of view and capturing the first image over the full first field of view using the sensor, and selectively blocking the full first field of view and capturing the second image over the full second field of view using the sensor. The selectively blocking may comprise using one or more mechanical or electrical shutters, such as liquid crystal layers. The first and second images are captured alternately. A sequence of first images may be recorded over a first period of time, before recording one or more second images.

The second field of view may extend perpendicular to the entrance lens surface of the camera in an area of the lens not covered by the first prism.

In one such embodiment, the method may further comprise disposing a second reflective prism in front of the camera adjacent to the first prism and separated by a gap there between, such the second prism deflects light from a third field of view onto the sensor of the camera, wherein the third field of view extends symmetrically around a different non-perpendicular direction relative to an entrance lens surface of the camera compared to the first field of view, and capturing a third image over at least a portion of the third field of view. The images over the respective fields of view may be captured individually using mechanical or electrical shutters.

The method may comprise using another camera to capture an image over another field of view, and forming a composite image based on two or more of a group consisting of the first image, the second image and the other image.

FIG. 17 shows a schematic diagram illustrating a camera device 1700 according to an example embodiment, comprising a first reflective prism 1702 disposed in front of a camera unit 1704 of the camera device 1700 such that the first prism 1702 deflects light from a first field of view onto a sensor 1706 of the camera unit 1704, wherein the first field of view extends symmetrically around a non-perpendicular direction relative to an entrance lens surface 1708 of the camera unit 1704, wherein the camera device 1700 is configured for capturing a first image over at least a portion of the first field of view using the sensor 1706 and for capturing a second image over at least a portion of a second field of view different from the first field of view using the same sensor 1706 with the first prism in place in front of the camera unit 1704.

The camera device 1700 may comprise a second reflective prism disposed in front of the camera unit 1704 adjacent to the first prism 1702 such that the second prism deflects light from the second field of view onto the sensor 1706 of the camera unit 1704, wherein the second field of view extends symmetrically around a different non-perpendicular direction relative to the entrance lens surface 1708 of the camera unit 1704 compared to the first field of view.

The prism 1702 may comprise a cube-prism, and the first and second fields of views may extend from orthogonal sides of the cube-prism.

The camera device 1700 may be configured such that the first and second images may be captured simultaneously.

In one such embodiment, the camera device 1700 may comprise a first light shield for blocking another portion of the first field of view and a second light shield for blocking another portion of the second field of view using a second light shield, and the camera device 1700 is configured such that the simultaneously captured images are recorded on different respective areas of the sensor 1706.

In one such embodiment, the camera device 1700 may comprise a first filter configured for being applied during capturing of the first image over the full first field of view and a different second filter configured for being applied during capturing of the second image over the full second field of view, and the camera device 1700 is configured such that the simultaneously captured images are captured on different color components of the sensor 1706.

The camera device 1700 may be configured such that the first and second images may be captured individually.

In one such embodiment, the camera device 1700 may comprise blocking means for selectively blocking the full second field of view and capturing the first image over the full first field of view using the sensor 1706, and for selectively blocking the full first field of view and capturing the second image over the full second field of view using the sensor 1706. The blocking means may comprise one or more mechanical or electrical shutters, such as liquid crystal layers. The camera device 1700 may be configured such that the first and second images are captured alternately. The camera device 1700 may be configured such that a sequence of first images may be recorded over a first period of time, before recording one or more second images.

The second field of view may extend perpendicular to the entrance lens surface 1708 of the camera unit 1704 in an area of the lens not covered by the first prism 1702.

In one such embodiment, the camera device 1700 may further comprise a second reflective prism disposed in front of the camera adjacent to the first prism 1702 and separated by a gap there from, such the second prism deflects light from a third field of view onto the sensor 1706 of the camera unit 1704, wherein the third field of view extends symmetrically around a different non-perpendicular direction relative to an entrance lens surface 1708 of the camera unit 1704 compared to the first field of view, and the camera device 1700 may be configured for capturing a third image over at least a portion of the third field of view. The camera device 1700 may be configured such that the images over the respective fields of view may be captured individually using mechanical or electrical shutters.

The camera device 1700 may comprise another camera unit to capture an image over another field of view, and the camera device 1700 may be configured for forming a composite image based on two or more of a group consisting of the first image, the second image and the other image.

Embodiments of the present invention can have one or more of the following features and benefits/advantages:

| Feature | Benefit/Advantage |
|---|---|
| Wide angle viewing produced by two | Allows wide-angle images to be generated |
| miniature cameras. A composite image is | from a flat device surface, since both cameras |
| formed with low distortion. | are in the same plane. The most obvious |
| | application is using the pair of smartphone |
| | cameras located on their back surface. |
| Wide angle viewing produced by a single | Allows wide-angle images to be generated |
| miniature camera. A composite image is | from one camera, thereby greatly extending |
| formed with low distortion by sequentially | the functionality and range of imaging |
| recording images in each direction. | possibilities. |
| Array of two cameras can be used to form a | Can be used to see over a 180° FOV at |
| field of view of 180°, providing far lower | the rear and front of a car |
| distortion compared to a fisheye lens or | |
| standard wide angle lens. | |
| Allows smartphones to generate wide angle | Extends viewing angle of smartphones from a |
| fields of view when more than one camera is | single camera horizontal field of view |
| used simultaneously. Hence, for the front | to ~140°, and ~180° if two |
| camera, ‘selfies’ can be recorded over very | cameras are used. |
| wide angles. For the rear camera, wide angle | |
| panoramas can be recorded at one time, rather | |
| than the user having to rotate the camera body | |
| in a ‘panorama’ mode. | |
| Provides a means for light to be detected (and | Present light detectors for LiFi have a |
| transmitted) over a wide entrance angular | FOV of ~60°. Trying to make larger |
| range, for applications in a range of fields such | than this produces large, bulky devices. |
| as LiFi, in a small, compact volume, with the | |
| need for bulky light collection optics. | |
| Provides a means for light to be recorded over | Allows multiple fields of view to be viewed on |
| the full field of view from different directions | the same camera with rapid switching between |
| on the same camera by electrically or | them, thereby removing the need to |
| mechanically opening/closing light shields so | mechanically rotate the camera to different |
| that only one direction is detected by the | directions. |
| camera sensor at any one time. | |

Applications of embodiments of the present invention include, but are not limited to:
Addressing limited field of view using only a single camera, whether for smartphones or any imaging application such as laptops, security cameras, drones, where a wider field of view would be preferable in one or two viewing planes.
For smartphones, there is presently no way of combining images from different fields of views for still or video images as it would necessitate adding on bulky optics—embodiments of the present invention can provide this solution, giving a highly original function to smartphones which could give a single interested manufacturer an edge over competitors.
For LiFi receivers—embodiment of the present invention allow collection and/or transmission of light over wider angles than can presently be achieved without using bulky optics.

Aspects of the systems and methods such as, but not limited to, configuring a camera unit to perform image capture, timing of image capture, and processing of captured images, including e,g, stitching of images, as described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

We claim:

1. A method of recording an image using a camera, the method comprising the steps of:
disposing a first reflective prism in front of the camera such that the first prism deflects light from a first field of view onto a sensor of the camera, wherein the first field of view extends symmetrically around a non-perpendicular direction relative to an entrance lens surface of the camera;
capturing a first image over at least a portion of the first field of view using the sensor; and
capturing a second image over at least a portion of a second field of view different from the first field of view using the same sensor with the first reflective prism in place in front of the camera.

2. The method of claim 1, comprising disposing a second reflective prism in front of the camera adjacent to the first reflective prism such that the second reflective prism deflects light from the second field of view onto the sensor of the camera, wherein the second field of view extends symmetrically around a different non-perpendicular direction relative to the entrance lens surface of the camera compared to the first field of view.

3. The method of claim 1, wherein the first reflective prism comprises a cube-prism, and the first and second fields of views may extend from orthogonal sides of the cube-prism.

4. The method of claim 1, wherein the first and second images are captured simultaneously, and optionally comprising blocking another portion of the first field of view using a first light shield and blocking another portion of the second field of view using a second light shield, and the simultaneously-captured images are recorded on different respective areas of the sensor; or
comprising blocking another portion of the first field of view using a first light shield and blocking another portion of the second field of view using a second light shield, and the simultaneously-captured images are recorded on different respective areas of the sensor.

5. (canceled)

6. (canceled)

7. The method of claim 1, wherein the first and second images are captured individually.

8. The method of claim 7, comprising selectively blocking the full second field of view and capturing the first image over the full first field of view using the sensor, and selectively blocking the full first field of view and capturing the second image over the full second field of view using the sensor.

9. The method of claim 8, wherein selectively blocking comprises using one or more mechanical or electrical shutters, such as liquid crystal layers, wherein optionally the first and second images are captured alternately, and/or wherein optionally a sequence of first images is recorded over a first period of time, before recording one or more second images.

10. (canceled)

11. (canceled)

12. The method of claim 1, wherein the second field of view extends perpendicular to the entrance lens surface of the camera in an area of the lens not covered by the first prism.

13. The method of claim 12, comprising disposing a second reflective prism in front of the camera adjacent to the first reflective prism and separated by a gap there between, such the second reflective prism deflects light from a third field of view onto the sensor of the camera, wherein the third field of view extends symmetrically around a different non-perpendicular direction relative to an entrance lens surface of the camera compared to the first field of view, and capturing a third image over at least a portion of the third field of view, and capturing a third image over at least a portion of the third field of view, wherein optionally the images over the respective fields of view are captured individually using mechanical or electrical shutters.

14. (canceled)

15. The method of claim 1, comprising using another camera to capture an image over another field of view, and forming a composite image based on two or more of a group consisting of the first image, the second image and the other image.

16. A camera device comprising:
a first reflective prism disposed in front of a camera unit of the camera device such that the first reflective prism deflects light from a first field of view onto the sensor of the camera unit, wherein the first field of view extends symmetrically around a non-perpendicular direction relative to an entrance lens surface of the camera unit;
wherein the camera device is configured for capturing a first image over at least a portion of the first field of view using the sensor and for capturing a second image over at least a portion of a second field of view different from the first field of view using the same sensor with the first reflective prism in place in front of the camera unit.

17. The camera device of claim 16, comprising a second reflective prism disposed in front of the camera unit adjacent to the first reflective prism such that the second reflective prism deflects light from the second field of view onto the sensor of the camera unit, wherein the second field of view extends symmetrically around a different non-perpendicular direction relative to the entrance lens surface of the camera unit compared to the first field of view.

18. The camera device of claim 16, wherein the first reflective prism comprises a cube-prism, and the first and second fields of views may extend from orthogonal sides of the cube-prism.

19. The camera device of claim 16, configured such that the first and second images may be captured simultaneously, and optionally
comprising a first light shield for blocking another portion of the first field of view and a second light shield for blocking another portion of the second field of view using a second light shield, and the camera device is configured such that the simultaneously captured images are recorded on different respective areas of the sensor; or
comprising a first filter configured for being applied during capturing of the first image over the full first field of view and a different second filter configured for being applied during capturing of the second image over the full second field of view, and the camera device is configured such that the simultaneously captured images are captured on different color components of the sensor.

20. (canceled)

21. (canceled)

22. The camera device of claim 16, configured such that the first and second images may be captured individually, and optionally configured such that a sequence of first images is recorded over a first period of time, before recording one or more second images.

23. The camera device of claim 22, comprising blocking means for selectively blocking the full second field of view and capturing the first image over the full first field of view using the sensor, and for selectively blocking the full first field of view and capturing the second image over the full second field of view using the sensor, and optionally wherein the blocking means comprises one or more mechanical or electrical shutters, such as liquid crystal layers.

24. (canceled)

25. The camera device of claim 22, configured such that the first and second images are captured alternately.

26. (canceled)

27. The camera device of claim 16, wherein the second field of view extends perpendicular to the entrance lens surface of the camera unit in an area of the lens not covered by the first reflective prism.

28. The camera device of claim 27, comprising a second reflective prism disposed in front of the camera adjacent to the first reflective prism and separated by a gap there from, such the second reflective prism deflects light from a third field of view onto the sensor of the camera unit, wherein the third field of view extends symmetrically around a different non-perpendicular direction relative to an entrance lens surface of the camera unit compared to the first field of view, and the camera device is configured for capturing a third image over at least a portion of the third field of view, and optionally configured such that the images over the respective fields of view are captured individually using mechanical or electrical shutters.

29. (canceled)

30. The camera device of claim 16, comprising another camera unit to capture an image over another field of view, and the camera device is configured for forming a composite image based on two or more of a group consisting of the first image, the second image and the other image.
